(19) United States
(12) Patent Application Publication
(10) Pub. No.: US 2019/0270137 A1
(43) Pub. Date: Sep. 5, 2019

(54) SYSTEM AND METHODS FOR MANUFACTURING REGENERATIVELY COOLED ROCKET THRUST CHAMBER NOZZLES

(71) Applicant: Karl F. HRANKA, Seal Beach, CA (US)

(72) Inventor: Karl F. HRANKA, Seal Beach, CA (US)

(21) Appl. No.: 16/290,616

(22) Filed: Mar. 1, 2019

Related U.S. Application Data
(60) Provisional application No. 62/637,276, filed on Mar. 1, 2018.

(51) Int. Cl. B22F 3/00; B33Y 10/00; B33Y 30/00; B22F 3/24; B33Y 70/00

(52) U.S. Cl. CPC B22F 3/008; B33Y 10/00; F02K 9/64; B22F 3/24; B33Y 70/00; B33Y 30/00

(57) ABSTRACT

In the area of rocket engines, regeneratively cooled rocket engines currently undergo long manufacturing time frames. This deters the speed of the development process resulting in a longer time to get to the market with a proven new design. There is a need to create methods that can manufacture regeneratively cooled rocket engines faster with a quick time to the market. This disclosure relates to faster methods for manufacturing regeneratively cooled rocket thrust chamber nozzles that use rocket propellant fluids to cool the chamber walls of the nozzle itself before being injected and burned. Furthermore, the new methods lead to enhanced designs that could enable reusable rocket engines by limiting overall fatigue with novel materials.

### CROSS REFERENCE TO RELATED APPLICATIONS

This application claims the benefit under 35 USC 119(e) of U.S. Provisional Patent Application No. 62/637,276, filed Mar. 1, 2018 the contents of which are incorporated herein by reference in their entirety for all purposes.

### FIELD OF THE DISCLOSURE

This relates generally to methods for manufacturing regeneratively cooled rocket thrust chamber nozzles. More particularly, this disclosure relates to faster methods for manufacturing regeneratively cooled rocket thrust chamber nozzles that use rocket propellant fluids to cool the chamber walls of the nozzle itself before being injected and burned. Furthermore, the new methods lead to enhanced designs that enable reusable rocket engines by limiting overall fatigue with novel materials.

### BACKGROUND OF THE DISCLOSURE

Traditionally, materials are processed into desired shapes and assemblies through a combination of rough fabrication techniques (e.g., casting, rolling, forging, extrusion, and stamping) and finish fabrication techniques (e.g., machining, welding, soldering, polishing). Producing a complex assembly in final, usable form (“net shape”), which may require not only forming the part with the desired materials in the proper shapes but also providing the part with the desired combination of metallurgical properties (e.g., various heat treatments, work hardening, complex microstructure), typically requires considerable investment in time, tools, and effort. One or more of the rough and finish processes may be performed using manufacturing centers, such as Computer Numerically Controlled (CNC) machine tools. Such machine tools include lathes, milling machines, grinding machines, and other tool types.

More recently, machining centers have been developed which provide a single machine having multiple tool types capable of performing multiple different machining processes. Machining centers may generally include one or more tool retainers, such as spindle retainers and turret retainers holding one or more tools, and a workpiece retainer, such as a pair of chucks. The workpiece retainer may be stationary or move (in translation and/or rotation) while a tool is brought into contact with the workpiece, thereby performing a subtractive manufacturing process during which material is removed from the workpiece.

Because of cost, expense, complexity, and other factors, more recently there has been interest in alternative techniques which would allow part or all of the conventional materials fabrication procedures to be replaced by additive manufacturing techniques. In contrast to subtractive manufacturing processes, which focus on precise removal of material from a workpiece, additive manufacturing processes precisely add material, typically in a computer-controlled environment. Additive manufacturing techniques may improve efficiency and reduce waste while expanding manufacturing capabilities, such as by permitting seamless construction of complex configurations which, when using conventional manufacturing techniques, would have to be assembled from a plurality of component parts. For the purposes of this specification, the term ‘plurality’ consistently is taken to mean “two or more.” The opportunity for additive techniques to replace subtractive processes depends on several factors, such as the range of materials available for use in the additive processes, the size and surface finish that can be achieved using additive techniques, and the rate at which material can be added. Additive processes may advantageously be capable of fabricating complex precision netshape components ready for use. In some cases, however, the additive process may generate “near-net shape” products that require some degree of finishing. In general, additive and subtractive processing techniques have developed substantially independently, and therefore have overlooked synergies that may result from combining these two distinct types of processes and the apparatus for performing them. Moreover, these synergies could be utilized in a variety of areas, such as manufacturing of tools, medical components and rocket engines etc.

In the area of rocket engines, regeneratively cooled rocket engines currently undergo long manufacturing time frames. This deters the speed of the development process, resulting in a longer time to get to the market with a proven new design. There is a need to create methods that can manufacture regeneratively cooled rocket engines faster with a quick time to the market.

### SUMMARY OF THE DISCLOSURE

This disclosure relates generally to methods for manufacturing regeneratively cooled rocket thrust chamber nozzles. More particularly, this disclosure relates to faster methods for manufacturing regeneratively cooled rocket thrust chamber nozzles that use rocket propellant fluids to cool the chamber walls of the nozzle itself before being injected and burned. Furthermore, the new methods lead to enhanced designs that enable reusable rocket engines by limiting overall fatigue with novel materials.

New methods of manufacturing a rocket nozzle are disclosed using a combination of additive and subtractive manufacturing techniques. Regeneratively cooled rocket engines often use copper based alloys for the inner core of the jacket and high temperature-high strength alloys for the outer core of the chamber. In between these cores are channels for the cold rocket propellant fluid to travel and cool the chamber.

The inner core of the jacket can be manufactured using a cold spray process. A subtractive operation (CNC machining) may be used to remove some copper material and may result in a refined surface finish. The cooling channels may be put into place in this removal process. Another metal additive process using a different alloy (high temp-high strength) may be applied over the top of this layer to close the channels. After that, a subtractive (drilling, turning) process may be used to remove the mandrel to expose the inner core.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an exemplary system based on regeneratively cooled rocket thrust chamber nozzles according to examples of the disclosure.

FIG. 2A illustrates an exemplary mandrel created as an inside shape of the rocket design according to examples of the disclosure.

FIG. 2B illustrates an exemplary mandrel cold sprayed with a high thermal conductivity copper based metal alloy according to examples of the disclosure.

FIG. 2C illustrates an exemplary mandrel with cooling channels after a subtractive operation is used to remove some copper material according to examples of the disclosure.

FIG. 3 illustrates an exemplary cross section of a mandrel after an additive process using a different alloy is applied over the top to close the channels according to examples of the disclosure.

FIG. 4 illustrates an exemplary finished mandrel after a subtractive process is used to expose the inner core according to examples of the disclosure.

FIG. 5A illustrates a rocket engine at the end of an exemplary manufacturing step 1 according to examples of the disclosure.

FIG. 5B illustrates a rocket engine at the end of an exemplary manufacturing step 2 according to examples of the disclosure.

FIG. 5C illustrates a rocket engine at the end of an exemplary manufacturing step 3 according to examples of the disclosure.

FIG. 5D illustrates a rocket engine at the end of an exemplary manufacturing step 4 according to examples of the disclosure.

FIG. 5E illustrates a rocket engine at the end of an exemplary manufacturing step 5 according to examples of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

Various techniques and process flow steps will be described in detail with reference to examples as illustrated in the accompanying drawings. In the following description, numerous specific details are set forth in order to provide a thorough understanding of one or more aspects and/or features described or referenced herein. It will be apparent, however, to one skilled in the art, that one or more aspects and/or features described or referenced herein may be practiced without some or all of these specific details. In other instances, well-known process steps and/or structures have not been described in detail in order to not obscure some of the aspects and/or features described or referenced herein.

Further, although process steps or method steps can be described in a sequential order, such processes and methods can be configured to work in any suitable order. In other words, any sequence or order of steps that can be described in the disclosure does not, in and of itself, indicate a requirement that the steps be performed in that order. Further, some steps may be performed simultaneously despite being described or implied as occurring non-simultaneously (e.g., because one-step is described after the other step). Moreover, the illustration of a process by its depiction in a drawing does not imply that the illustrated process is exclusive of other variations and modification thereto, does not imply that the illustrated process or any of its steps are necessary to one or more of the examples, and does not imply that the illustrated process is preferred.

Traditionally, materials are processed into desired shapes and assemblies through a combination of rough fabrication techniques (e.g., casting, rolling, forging, extrusion, and stamping) and finish fabrication techniques (e.g., machining, welding, soldering, polishing). Producing a complex assembly in final, usable form (“net shape”), which may require not only forming the part with the desired materials in the proper shapes but also providing the part with the desired combination of metallurgical properties (e.g., various heat treatments, work hardening, complex microstructure), typically requires considerable investment in time, tools, and effort. One or more of the rough and finish processes may be performed using manufacturing centers, such as Computer Numerically Controlled (CNC) machine tools. Such machine tools include lathes, milling machines, grinding machines, and other tool types.

More recently, machining centers have been developed which provide a single machine having multiple tool types capable of performing multiple different machining processes. Machining centers may generally include one or more tool retainers, such as spindle retainers and turret retainers holding one or more tools, and a workpiece retainer, such as a pair of chucks. The workpiece retainer may be stationary or move (in translation and/or rotation) while a tool is brought into contact with the workpiece, thereby performing a subtractive manufacturing process during which material is removed from the workpiece.

Because of cost, expense, complexity, and other factors, more recently there has been interest in alternative techniques which would allow part or all of the conventional materials fabrication procedures to be replaced by additive manufacturing techniques. In contrast to subtractive manufacturing processes, which focus on precise removal of material from a workpiece, additive manufacturing processes precisely add material, typically in a computer-controlled environment. Additive manufacturing techniques may improve efficiency and reduce waste while expanding manufacturing capabilities, such as by permitting seamless construction of complex configurations which, when using conventional manufacturing techniques, would have to be assembled from a plurality of component parts. For the purposes of this specification and the appended claims, the term ‘plurality’ consistently is taken to mean “two or more.” The opportunity for additive techniques to replace subtractive processes depends on several factors, such as the range of materials available for use in the additive processes, the size and surface finish that can be achieved using additive techniques, and the rate at which material can be added. Additive processes may advantageously be capable of fabricating complex precision netshape components ready for use. In some cases, however, the additive process may generate “near-net shape” products that require some degree of finishing. In general, additive and subtractive processing techniques have developed substantially independently, and therefore have overlooked synergies that may result from combining these two distinct types of processes and the apparatus for performing them. Moreover, these synergies could be utilized in a variety of areas, such as, manufacturing of tools, medical components and rocket engines etc.

In the area of rocket engines, regeneratively cooled rocket engines currently undergo long manufacturing time frames. This deters the speed of the development process resulting in a longer time to get to the market with a proven new design. There is a need to create methods that can manufacture regeneratively cooled rocket engines faster with a quick time to the market.

This disclosure relates generally to methods for manufacturing regeneratively cooled rocket thrust chamber nozzles. More particularly, this disclosure relates to faster methods for manufacturing regeneratively cooled rocket thrust chamber nozzles that use rocket propellant fluids to cool the chamber walls of the nozzle itself before being injected and burned. Furthermore, the new methods lead to enhanced designs that could enable reusable rocket engines by limiting overall fatigue with novel materials.

New methods of manufacturing a rocket nozzle are disclosed using a combination of additive and subtractive manufacturing techniques. Regeneratively cooled rocket engines often use copper based alloys for the inner core of the jacket and high temperature-high strength alloys for the outer core of the chamber. In between these cores are channels for the cold rocket propellant fluid to travel and cool the chamber.

The inner core of the jacket can be manufactured using a cold spray process. A subtractive operation (CNC machining) may be used to remove some copper material and may result in a refined surface finish. The cooling channels may be put into place in this removal process. Another metal additive process using a different alloy (high temp-high strength) may be applied over the top of this layer to close the channels. After that, a subtractive (drilling, turning) process may be used to remove the mandrel to expose the inner core.

Representative applications of methods and apparatus according to the present disclosure are described in this section. These examples are being provided solely to add context and aid in the understanding of the described examples. It will thus be apparent to one skilled in the art that the described examples may be practiced without some or all of the specific details. In other instances, well-known process steps have been described in detail in order to avoid unnecessarily obscuring the described examples. Other applications are possible, such that the following examples should not be taken as limiting.

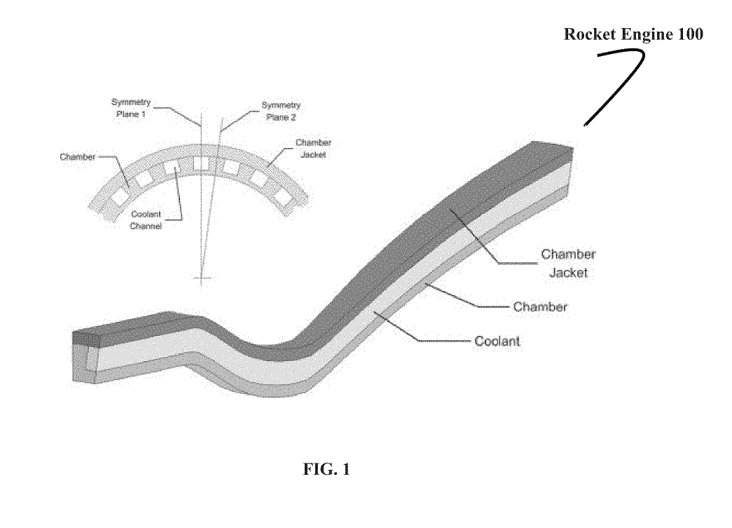

FIG. 1 illustrates an exemplary system based on regeneratively cooled rocket thrust chamber nozzle according to examples of the disclosure. In some embodiments of the invention, the new regeneratively cooled rocket nozzle can use rocket propellant fluids to cool the chamber walls of the nozzle itself before being injected and burned. Additionally, new regeneratively cooled rocket nozzle can enable reusable rocket engines by limiting overall fatigue with novel materials.

The new rocket nozzle can be developed using additive manufacturing techniques. In some embodiments of the invention, regeneratively cooled rocket engines can use copper based alloys for the inner core of the jacket and high temperature-high strength alloys for the outer core of the chamber. In between these cores, there can be channels for the cold rocket propellant fluid to travel and cool the chamber. In some embodiments, a rocket nozzle thrust chamber can be made with an inner chamber and an outer chamber jacket. In between the inner and outer chamber, there can be channels that guide the coolant fluid. The inner chamber can include the walls that separate coolant channels. In some embodiments, the inner chamber can be made of high thermal conductivity alloys, whereas the outer jacket can be made with high strength at high temperature alloys.

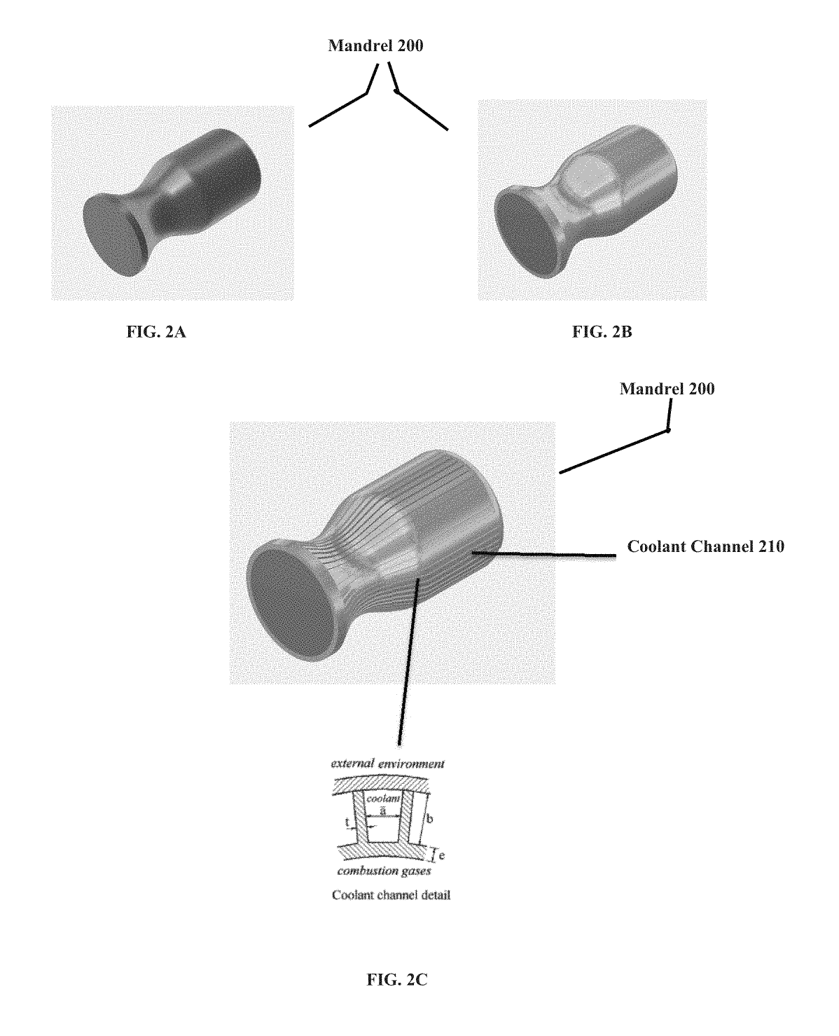

FIG. 2A-4 together illustrate one exemplary method for manufacturing regeneratively cooled rocket thrust chamber nozzles.

FIG. 2A illustrates an exemplary mandrel created as an inside shape of the rocket design according to examples of the disclosure. A mandrel can be created to the inside shape of the rocket design. This mandrel can be a sacrificial body and not part of the final structure. In a separate embodiment of the invention, this mandrel can be created using an additive manufacturing process.

FIG. 2B illustrates an exemplary mandrel cold sprayed with a high thermal conductivity copper based metal alloy according to examples of the disclosure. A high thermal conductivity copper based metal alloy can be applied in a cold spray process around the mandrel. In a separate embodiment of the invention, the copper alloy can be alloyed with diamond powder to increase its thermal conductivity.

FIG. 2C illustrates an exemplary mandrel with cooling channels after a subtractive operation is used to remove some copper material according to examples of the disclosure. A subtractive operation (CNC machining) can be used to remove some copper material and result in a refined surface finish. The cooling channels can be put into place in this removal process.

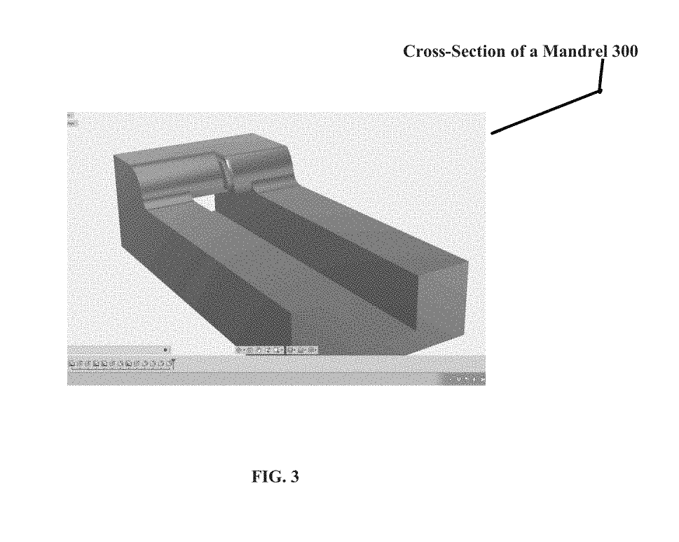

FIG. 3 illustrates an exemplary cross section of a mandrel after an additive process using a different alloy is applied over the top to close the channels according to examples of the disclosure. Another metal additive process using a different alloy (high temp-high strength typically) can be applied over the top of this layer to close the channels. In one embodiment of the invention, a wire-arc method can be used wherein wire can be pulsed at a high frequency to enable rapid cooling of the metal. Since the liquid metal has surface tension it may not flow out and instead may stay adhered to the bridging metal. The liquid metal may adhere to the walls too.

In another embodiment of the invention, a laser, arc, or cold spray with filler method can be used wherein a filler material can be placed in the channels and the channels can be printed over with material. After the printing of the channels, the filler material can be removed.

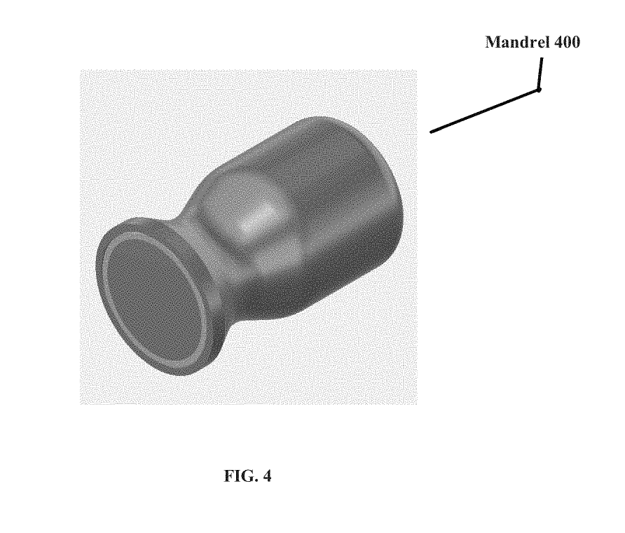

FIG. 4 illustrates an exemplary finished mandrel after a subtractive process if used to expose the inner core according to examples of the disclosure. In the end, a subtractive (drilling, turning) process can be used to remove the mandrel to expose the inner core.

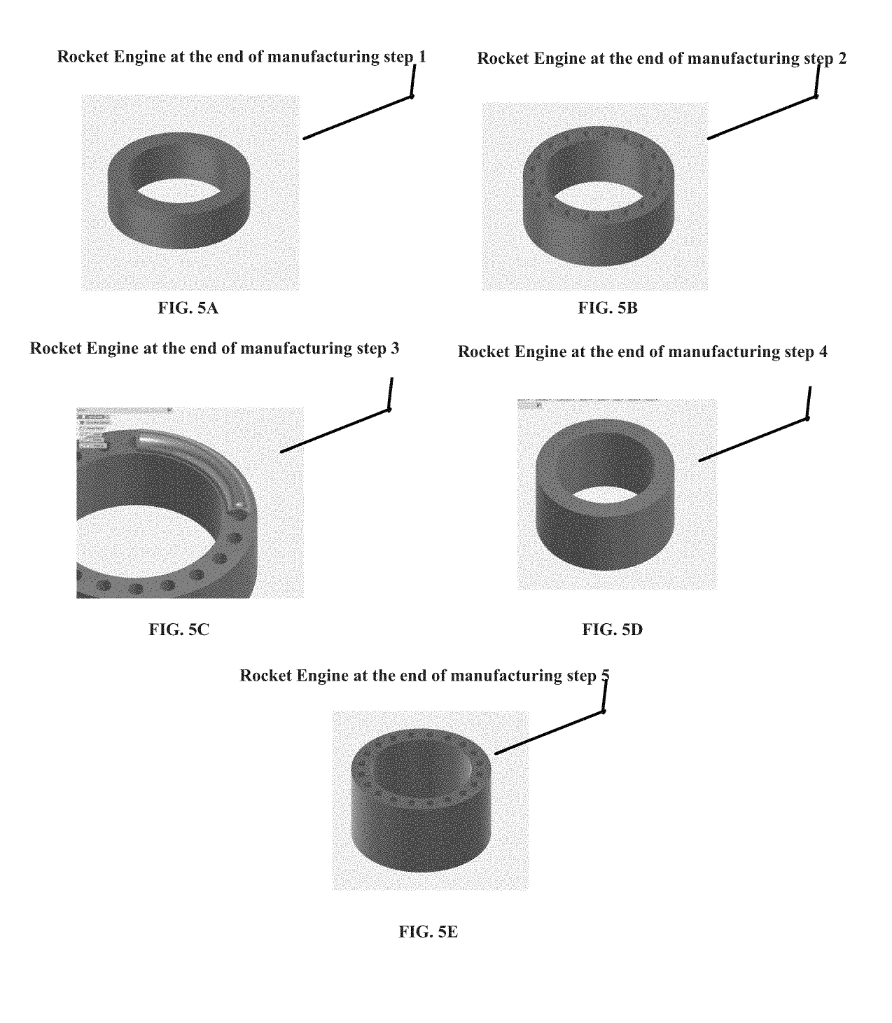

FIG. 5A-5E together illustrate another exemplary method with separate steps for manufacturing regeneratively cooled rocket thrust chamber nozzles. These steps may not be performed in any particular order.

FIG. 5A illustrates a rocket engine at the end of an exemplary manufacturing step 1 according to examples of the disclosure. During manufacturing step 1, a first material is additively manufactured or prepared from billet.

FIG. 5B illustrates a rocket engine at the end of an exemplary manufacturing step 2 according to examples of the disclosure. During manufacturing step 2, a subtractive operation (drilling, milling) is used to create channels.

FIG. 5C illustrates a rocket engine at the end of an exemplary manufacturing step 3 according to examples of the disclosure. During manufacturing step 3, a closure method-wire arc tool of additive manufacturing is used. Due to the nature of the high pulsing of the wire and current, the material can be allowed to solidify fast without dripping/flowing away. The instant surface tension of the liquid metal may keep it affixed to the substrate rather than flowing deep into the holes.

FIG. 5D illustrates a rocket engine at the end of an exemplary manufacturing step 4 according to examples of the disclosure. During manufacturing step 4, the material can continue to be built up, with sealed over the top holes underneath

FIG. 5E illustrates a rocket engine at the end of an exemplary manufacturing step 5 according to examples of the disclosure. During manufacturing step 5, the subtractive operation (drilling, milling) can be used to connect back through to the channels below.

1. A method of manufacturing a regeneratively cooled rocket device, the method comprising:
creating a mandrel as an inside shape of the regeneratively cooled rocket device;
cold spraying the mandrel with a high thermal conductivity copper based metal alloy;
removing a portion of the copper based metal alloy using a subtractive operation to at least partially create cooling channels in the mandrel;
closing the cooling channels by applying a second alloy using an additive process; and
exposing inner core of the mandrel using a subtractive process.

2. The method of manufacturing a regeneratively cooled rocket device of claim 1, wherein closing the cooling channels further comprises:
placing a filler material into the cooling channels; and
applying the second alloy onto the filler material and portions of the copper based metal alloy not covered by the filler material;
wherein the filler material is configured not to bond to the second alloy.

3. The method of manufacturing a regeneratively cooled rocket device of claim 1, wherein:
the additive process for applying the second alloy further comprises depositing the second alloy as a liquid metal using a wire-arc method; and
the wire-arc method comprises generating an alternating current with a first frequency in a wire used to deposit the second alloy as a liquid metal on an outer surface of the copper based metallic alloy.

4. The method of manufacturing a regeneratively cooled rocket device of claim 3, wherein the wire-arc method further comprises generating an alternating current in the wire based on a desired surface tension of the second alloy as a liquid metal to substantially prevent the second alloy as a liquid metal from flowing into the at least partially created cooling channels.

5. The method of manufacturing a regeneratively cooled rocket device of claim 1, wherein removing a portion of the copper based metal alloy further comprises creating cooling channels with substantially uniform dimensions and a substantially uniform spacing between each cooling channel.

6. The method of manufacturing a regeneratively cooled rocket device of claim 1, the method further comprising:
placing filler material on a top surface of the mandrel, a first terminal region of each of the respective cooling channels covered by the filler material placed on the top surface;
shaping the filler material placed on the top surface based on a desired cross section of a first flow channel to fluidly couple each of the cooling channels; and
creating the first flow channel by depositing a third alloy using a third additive process, wherein the third alloy is deposited onto the filler material on the top surface and onto a portion of the top surface not covered by the filler material.

7. The method of manufacturing a regeneratively cooled rocket device of claim 6, further comprising forming an access port of the first flow channel by removing a portion of the third alloy with the subtractive process.

8. The method of manufacturing a regeneratively cooled rocket device of claim 6, wherein the filler material comprises a ring shape of filler material covering each terminal portion of each respective cooling channel in the top surface of the mandrel.

9. The method of manufacturing a regeneratively cooled rocket device of claim 1, wherein the method further comprises:
selecting both a material of the mandrel and the additive process to create the mandrel based on a desired accuracy associated with a net shape of the mandrel created by the additive process.

10. The method of manufacturing a regeneratively cooled rocket device of claim 1, wherein creating the mandrel further comprises:
using a computer controlled 3D printing system to create the mandrel and
configuring a shape, size and durability of the mandrel during creation based on a chosen subtractive process to be used to expose the inner core of the mandrel after the cooling channels are closed by applying the second alloy.

11. The method of manufacturing a regeneratively cooled rocket device of claim 1, wherein the copper based metallic alloy comprises a high thermal conductivity copper based metal alloy with a diamond powder additive.

12. The method of manufacturing a regeneratively cooled rocket device of claim 1, further comprising determining one or more of a number of channels, a size or channels, or a shape of channels based on the thermal conductivity of the copper based alloy and a thermal conductivity of a fluid associated with the regeneratively cooled rocket device.

13. The method of manufacturing a regeneratively cooled rocket device of claim 1, further comprising creating an outlet channel fluidly coupled to the cooling channels and configured to communicate fluid from the cooling channels at a first rate of flow, wherein the outlet channel is formed using the additive process and the subtractive process.

14. An apparatus for manufacturing a regeneratively cooled rocket nozzle, the apparatus comprising:
an additive manufacturing assembly comprising
a 3D printing system configured to create a mandrel die based on a chamber profile associated with the regeneratively cooled rocket nozzle, and
a first metal deposition system configured to deposit a continuous layer of a copper alloy onto an outer surface of the mandrel die, wherein the continuous layer of the copper alloy forms an inner jacket of the rocket nozzle; and
a machining assembly comprising a first toolset configured to at least partially create a plurality of cooling channels in the inner jacket by removing portions of the inner jacket with a first subtractive process;
wherein the additive manufacturing assembly further comprises a second metal deposition system configured to deposit a second metallic alloy onto the inner jacket including the at least partially created plurality of cooling channels, wherein the deposited second metallic alloy forms an outer jacket of the rocket nozzle; and
wherein the machining assembly further comprises a second toolset configured to remove a portion of the mandrel die with a second subtractive process, exposing a surface of the inner jacket that is opposite a surface physically touching the outer jacket.

15. The apparatus for manufacturing the regeneratively cooled rocket nozzle of claim 14, wherein the first toolset of the machining assembly comprises at least one computer controlled drill.

16. The apparatus for manufacturing the regeneratively cooled rocket nozzle of claim 14, wherein the first toolset of the machining assembly comprises at least one computer numerically controlled milling bit.

17. The apparatus for manufacturing the regeneratively cooled rocket nozzle of claim 14, wherein for a high temperature relative to a range of operational temperatures associated with the rocket nozzle, a durability of the second alloy exceeds a durability of the copper based metallic alloy.

18. The apparatus for manufacturing the regeneratively cooled rocket nozzle of claim 14, wherein the second metal deposition system comprises an arc-wire method of metal deposition configured to generate an alternating current in a wire with an amplitude and frequency based on the second alloy to deposit as a liquid metal onto the inner jacket.
